(19) United States
(12) Patent Application Publication
(10) Pub. No.: US 2004/0114183 A1
(43) Pub. Date: Jun. 17, 2004

(54) Method and apparatus for image data storage management

(76) Inventor: Wei-Jen Lee, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/392,237

(22) Filed: Mar. 18, 2003

(30) Foreign Application Priority Data
Dec. 12, 2002 (TW) 91135984

(51) Int. Cl. G06F 15/00; H04N 1/327

(52) U.S. Cl. 358/1.16; 358/426.05

(57) ABSTRACT

A method and apparatus for digital image data storage management, utilizing software. The apparatus includes a data input unit, a storage medium with previously stored image data, and a data processing unit. When a newly obtained image file's size exceeds available space on the storage medium, the resolution of one or more of the existing images data is reduced to create additional available space. Finally, the newly obtained image file is stored on the storage medium.

### BACKGROUND OF THE INVENTION

1. Field of the Invention

The present invention relates to a method of data storage management, and in particular to a method of image data storage management.

2. Description of the Related Art

Conventional file formats of images used in digital video cameras are AVI (Audio Video Interleave), MPEG-1 (motion pictures expert group) or MPEG-2. The differences in file formats are based on compression format, compression ratio, and resolution.

FIG. 1 is a diagram showing a conventional storage medium for digital images. The storage medium 1 shown in FIG. 1 comprises image file 11, image file 13 and image file 15, each of which has an I-frame and a plurality of P-frames. The storage medium 1 can be a memory card, such as Smart Media (SM card), Memory Stick (MS card), Compact Flash (CF card), hard disc, CD-RW (Compact Disc Rewritable) or DVD-RW (Digital Versatile Disc Rewritable). If the total capacity of the storage medium 1 is 200 MB and image files 11, 13, and 15 are 100 MB, 50 MB and 50 MB, respectively, storage medium 1 has insufficient capacity for additional data. Even though new files may require only a fraction of the space currently occupied by any of the existing files (e.g. 10 MB), an existing stored file must be completely deleted to provide space.

A significant drawback of traditional image storage is thus the need to erase previously stored image files in their entirety to store newly obtained image files.

### SUMMARY OF THE INVENTION

Accordingly, an object of the present invention is to provide a more flexible method of image data storage management capable of gaining space in a storage medium, enabling storage of new image data.

Accordingly, the present invention also provides an apparatus for image data storage management, comprising a data input unit, a storage medium with several stored image files and a data processing unit. Each image file has a base layer stream and an enhancement layer stream having a plurality of data layers with respective image quality factors. If a newly obtained image file whose size exceeds available space on the storage medium is added, a portion of the data layers of the enhancement layer stream of the stored image files is erased, decreasing the image quality of the previously stored image file. Available space larger than or equal to the size of the newly obtained image file of the storage medium is thus.

The present invention makes use of Fine Granularity Scalability (FGS) of the Motion Pictures Expert Group-4 (MPEG-4) standard to erase a portion of the image quality factors of the data layers of the enhancement of the image file, decreasing the image quality of the image file to diminish the size of the image file, thereby acquiring additional available space on the storage medium.

A detailed description is given in the following embodiments with reference to the accompanying drawings.

### BRIEF DESCRIPTION OF THE DRAWINGS

The present invention can be more fully understood by reading the subsequent detailed description and examples with reference to the accompanying drawings, wherein:

FIG. 1 is a diagram showing a conventional storage device of management for digital image data storage;

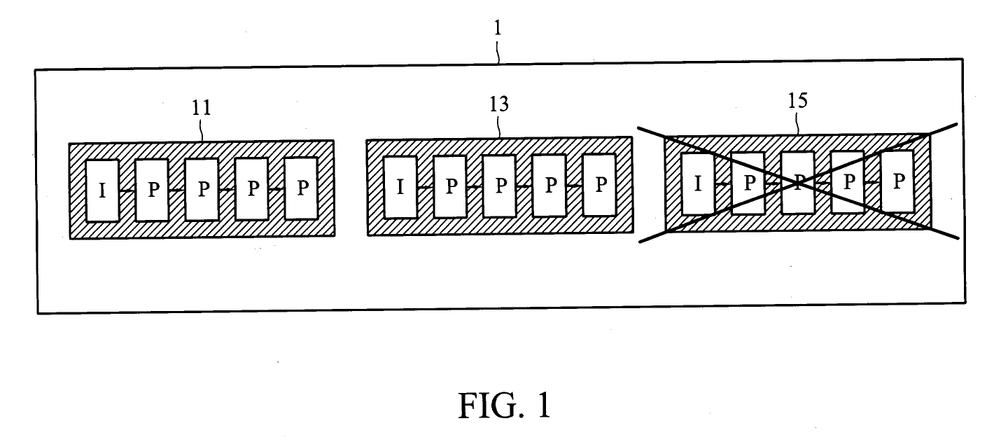

FIG. 2 is a diagram showing the architecture of image data storage management of the present invention;

FIG. 3 is a diagram showing the apparatus for image data storage management of the present invention;

FIG. 4 is a diagram showing the apparatus of a storage medium for erasing a portion of data layers of image file to gain additional available space in the storage medium of the present invention.

### DETAILED DESCRIPTION OF THE INVENTION

Accordingly, the present invention discloses a method and apparatus for image data storage management utilizing software to implement intelligent management of digital image content.

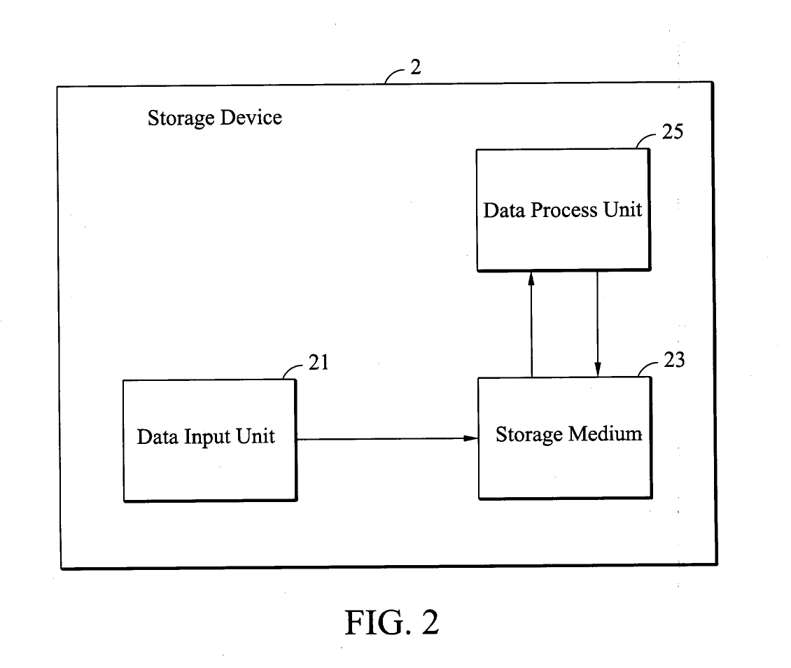

FIG. 2 is a diagram showing the architecture of image data storage management of the present invention. A storage device 2 of, for example, a digital video device, comprises a data input unit 21, a storage medium 23 with several image files and a data processing unit 25. Each image file has a base layer stream and an enhancement layer stream having a plurality of data layers with respective image quality factors. A newly obtained image file whose size exceeds available space on the storage medium 23 is retrieved from the data input unit 21. A portion of the data layers of the enhancement layer stream of the existing images data of the storage medium 23 through the data processing unit 25 is erased, decreasing the image quality of the previously stored image file, thereby creating additional available space on the storage medium 23 larger than or equal to the size of the newly obtained image file.

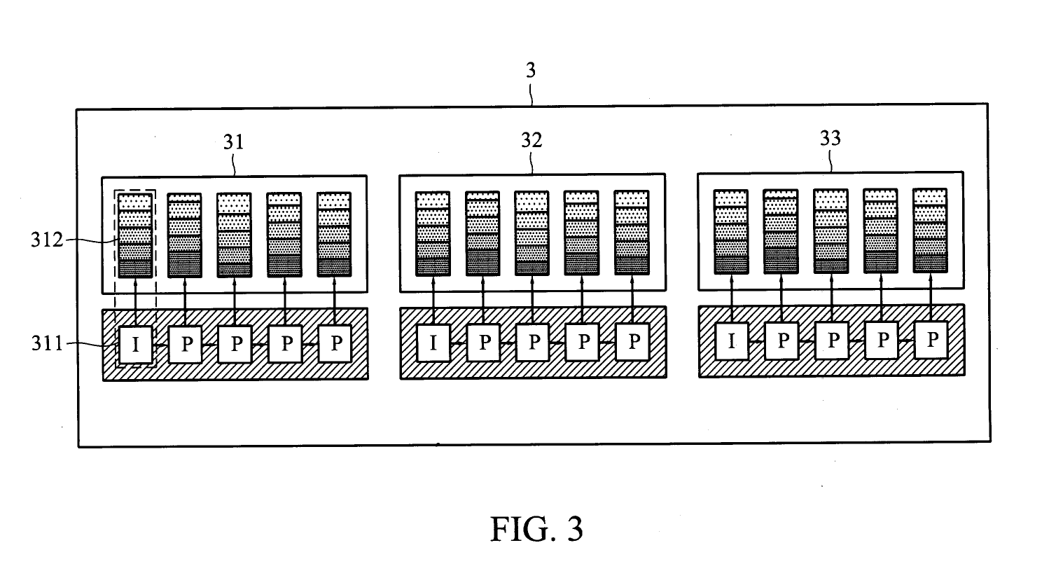

FIG. 3 is a diagram showing the apparatus for image data storage management of the present invention. The storage medium 3 of the storage device comprises image file 31, image file 33 and image file 35, in which each consists of a I-frame and a plurality of P-frames. Each frame is a picture of the image file, comprising a base layer stream 311 and an enhancement layer stream 312 having a plurality of data layers with respective image quality factors. Dissimilar image quality factors display different resolutions of the data layers of the image file.

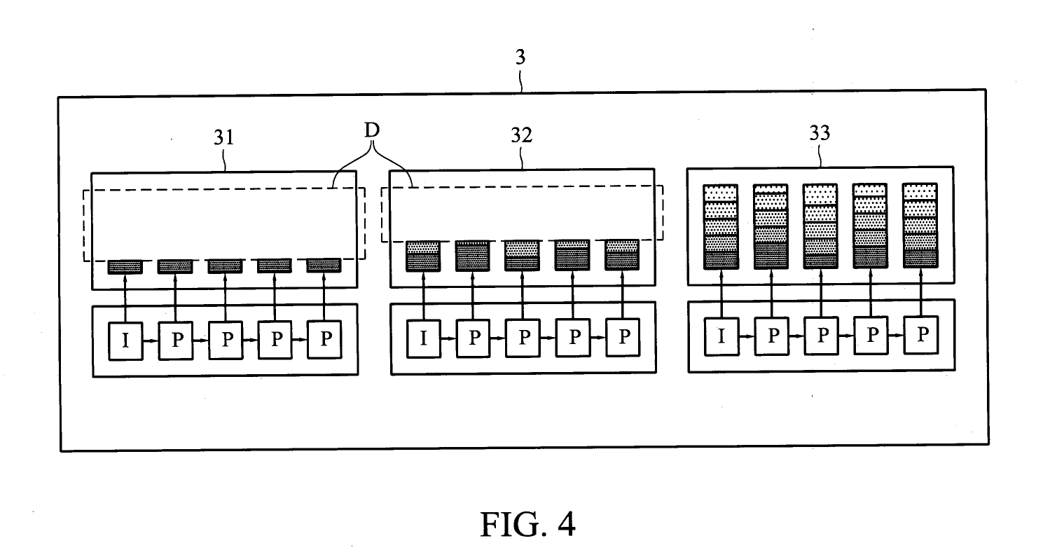

FIG. 4 is a diagram showing the apparatus of a storage medium for erasing a portion of data layers of image file to gain additional available space on the storage medium of the present invention. If, for example, the capacity of the storage medium 3 is 200 MB, and image file 31 is 100 MB, image file 32 is 50 MB, and image file 33 is 50 MB, then to add a newly obtained image file to storage medium 3, additional available space must be created. A portion of the data layers (as D shown in FIG. 4) of the image file 31 is erased, decreasing the resolution of the image file 31, and thereby obtaining additional available space on the storage medium 3. Similarly, erasing a portion of the data layers (as D shown in FIG. 4) of the image file 33, decreasing the resolution of the image file 33, thereby creating additional available space on the storage medium 3. Finally, the newly obtained image file is stored on the storage medium 3.

The present invention discloses a method of image data storage management utilizing the standard of MPEG-4 FGS to compress the image file, deleting part of the data layers of the enhancement of the image file to acquire more space to store more image files. The inventive method provides flexible and efficient image compression and management, dynamically configuring the compressed image files.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of image data storage management, comprising the steps of:
providing a storage medium for a storage device, comprising at least one image file having a base layer stream and an enhancement layer stream having a plurality of data layers with respective image quality factors;
obtaining a newly obtained image file whose size exceeds available space on the storage medium;
erasing a portion of the data layers of the enhancement layer stream of the at least one previously stored image file, thereby creating additional available space on the storage medium larger than or equal to the size of the newly obtained image file; and
storing the newly obtained image file in the newly created space.

2. The method as claimed in claim 1, wherein the format of the image file corresponds to FGS of MPEG-4.

3. The method as claimed in claim 1, wherein the base layer stream of the image file has lower image quality than the enhancement layer.

4. The method as claimed in claim 1, wherein the storage medium is a memory card, such as Smart Media, Memory Stick, Compact Flash, a hard disc, CD-RW or DVD-RW.

5. An apparatus for image data storage management, comprising:
a data input unit for obtaining an image file from a storage device;
a storage medium, coupled to the data input unit, for storing image files, comprising at least one previously stored image file having a base layer stream and an enhancement layer stream having a plurality of data layers with respective image quality factors; and
a data processing unit, coupled to the storage medium, for erasing a portion of the data layers of the enhancement layer stream of the at least one previously stored image file, thereby creating additional available space on the storage medium.

6. The method as claimed in claim 6, wherein the format of the image file corresponds to FGS of MPEG-4.

7. The method as claimed in claim 6, wherein the base layer stream of the image file has lower image quality than the enhancement layer.

8. The device as claimed in claim 6, wherein the enhancement layer stream comprises a plurality of data layers in which each has different image quality.

9. The device as claimed in claim 9, wherein a portion of the data layers of the enhancement layer stream is erased by the data processing unit of the storage device, thereby creating additional available storage space when obtaining a new image file whose size exceeds previously available space on the storage medium.

10. The device as claimed in claim 10, wherein the newly obtained image file is stored in the newly created available storage space on the storage medium.

11. The device as claimed in claim 6, wherein the storage medium is a memory card, such as Smart Media, Memory Stick, Compact Flash, a hard disc, CD-RW or DVD-RW.
